(19) United States
(12) Patent Application Publication
(10) Pub. No.: US 2025/0324923 A1
(43) Pub. Date: Oct. 23, 2025

(54) Nut Collector

(71) Applicant: Jiexin Cheng, Yongkang (CN)

(72) Inventor: Jiexin Cheng, Yongkang (CN)

(21) Appl. No.: 18/650,242

(22) Filed: Apr. 30, 2024

(30) Foreign Application Priority Data
Apr. 20, 2024 (CN) 202420832333X

(51) Int. Cl. A01D 51/00

(52) U.S. Cl. CPC A01D 51/002

(57) ABSTRACT

A nut collector, includes a collection cage and two hubs arranged two ends of the collection cage. The collection cage includes: two cages that are oppositely arranged and can be assembled together or separated from each other, namely a first cage and a second cage; each hub includes a first half hub, a second half hub and a locking component; the first half hub and the second half hub are respectively arranged at one end of the first cage and the second cage; a part of the locking component is arranged on the first half hub and other part is arranged on the second half hub, and the locking component is used for locking or separating the first half hub and the second half hub. There is no need to directly pull apart the elastic metal wires of the collection cage manually to reduce safety risks during use.

### TECHNICAL FIELD

The present utility patent relates to the technical field of nut collection tools, and in particular to a nut collector.

### BACKGROUND

After nuts such as hazelnuts, chestnuts, walnuts, and almonds mature, fall from trees and are scattered on nearby ground, the nuts need to be picked up and processed in time. Nuts scattered on the ground are usually collected by manual picking. However, due to the large area and large number of nuts scattered, manual picking of nuts often requires a lot of energy from the fruit farmers, and the efficiency of collecting nuts is also relatively low. Therefore, a handheld picking device namely a nut collector has appeared on the market, allowing fruit farmers to pick up nuts without bending over. After searching, the nut pickers in the prior art such as patent number of U.S. Pat. No. 9,445,545B2 namely “Nut gatherer and method of constructing same” discloses a nut collector which mainly includes a handle, a bracket connected to the handle and a collection cage rotationally connected to lower end of the bracket. A plurality of metal wires are installed on the collection cage. The metal wires can be compressed and deformed to cause larger gaps between two adjacent metal wires, forming a feed inlet with a hole diameter larger than diameter of the nuts, so that the nuts scattered on the ground can enter into the collection cage. The entire picking process is highly efficient, easy and convenient.

When the collection cage is full of nuts, the farmer needs to manually pull apart the two adjacent metal wires so that the collection cage has a discharge opening with a hole diameter larger than the diameter of the nuts, so that the nuts can be poured out smoothly from the discharge opening for the next picking. Because there are protruding tips on surface of some nuts, such as chestnut shells with spikes, flat mouths at both ends of almonds, and convex edges on surface of walnuts, the nuts can easily scratch hands of the fruit farmers during the above discharging operation. There are major safety risks in the use of the collector; in addition, manually pulling the two adjacent metal wires apart and pouring nuts repeatedly can easily cause the elastic metal wires to deform and affect subsequent use. Therefore, it requires further improvement

### SUMMARY OF THE PRESENT UTILITY PATENT

In order to overcome at least one defect of the above-mentioned prior art, the present utility patent provides a nut collector, so that fruit farmers do not need to use their hands to directly pull apart the elastic metal wires of the collection cage during the discharging operation, thereby reducing the deformation of the elastic metal wires, and increasing the service life, and at the same time, it can prevent the nuts from scratching the user, thereby reducing potential safety hazards during use.

In order to achieve the above purpose, the technical solutions is adopted by the present utility patent is: a nut collector, including a collection cage and two hubs arranged at two ends of the collection cage, wherein the collection cage is formed by a plurality of elastic metal wires distributed in a circumference and connected to two hubs at both ends; the collection cage includes: two cages oppositely arranged and capable of assembling together or separating from each other; each hub includes a first half hub, a second half hub and a locking component; the first half hub and the second half hub are respectively arranged on one end of the two cages; a part of the locking component is arranged on the first half hub and other part is arranged on the second half hub; the locking component is used for locking or separating the first half hub and the second half hub.

After adopting the above technical solution, the benefit effect of the present utility patent is: the two cages are capable of assembling as a whole collection cage with the first half hub, the second half hub and the locking component, which facilitates the user to pick up the nuts. When need to take out the nuts in the collection cage, the user can open the first half hub and the second half hub through the locking component, thereby achieving to separate the collection cage as two halves to facilitate taking out the nuts in the collection cage. There is no need to pull apart the adjacent metal wires when taking out the nuts, which prevents the nuts from scratching the user and reduces potential safety hazards during use.

### BRIEF DESCRIPTION OF THE FIGURES

To more clearly illustrate the technical solution of embodiments of the present utility patent or the prior art, a brief introduction of the figures that need to be used in the embodiments or the description of the prior art will be given below. Obviously, the figures in the following description are only some embodiments of the present utility patent. For those of ordinary skilled in the art, other figures can also be obtained based on these figures without inventive efforts.

FIG. 1 is a schematic structural diagram of the merging state of the collection cages of the present utility patent;

FIG. 2 is a schematic structural diagram of the first cage and the second cage of the present utility patent in a separated state;

FIG. 3 is a schematic structural diagram from another direction of the first cage and the second cage of the present utility patent in a separated state;

FIG. 4 is an exploded schematic diagram of the first half hub of the present utility patent;

FIG. 5 is an exploded schematic diagram of the second half hub of the present utility patent;

FIG. 6 is an exploded schematic view from another direction of the second half hub of the present utility patent;

### NOTE OF REFERENCE SIGNS

collection cage; 11. first cage; 12. second cage; 13. elastic metal wire; 2. first half hub; 201. first sliding groove; 202. first guiding groove; 203. first hole; 204, positioning groove; 21, first rotating part; 205, shaft hole; 206, third guiding groove; 22, hub cover; 23, hub plate; 24, fixed board; 25, first spacer gear group; 26. second spacer gear group; 207. recessed groove; 27. gasket; 3. second half hub; 301. second sliding groove; 302. second guiding groove; 303. second hole; 31. positioning column; 32. second rotating part; 304. fourth guiding groove; 4. locking component; 41. first locking block; 42. first toggle piece; 43. first limiting convex block; 45. second locking block; 46, second toggle piece; 47, second limiting convex block.

### DETAILED DESCRIPTION OF THE EMBODIMENTS

Below is a further detailed description of the present utility patent based on the figures.

The present embodiment only shows an explanation of the present utility patent and it is not a limitation to the present utility patent. The skilled in the art can make modifications to the present embodiment as needed without making any creative contributions after reading this specification, which are always protected by the patent law as long as they are within the scope of the claims of the present utility patent.

It should be noted that when an element is called as being “fixed to” or “arranged on” other element, it can be directly on the other element or indirectly on the other element. When an element is called as being “connected to” other element, it can be directly connected to the other element or indirectly connected to the other element.

It should be noticed that the terms “length”, “width”, “above”, “below”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present utility patent and simplifying the description, rather than indicating or implying that the device or component must have a specific orientation, construct and operate in a specific orientation, therefore, it understood as a limitation of the present utility patent.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present utility patent, “a plurality of” means two or more, unless otherwise specifically defined.

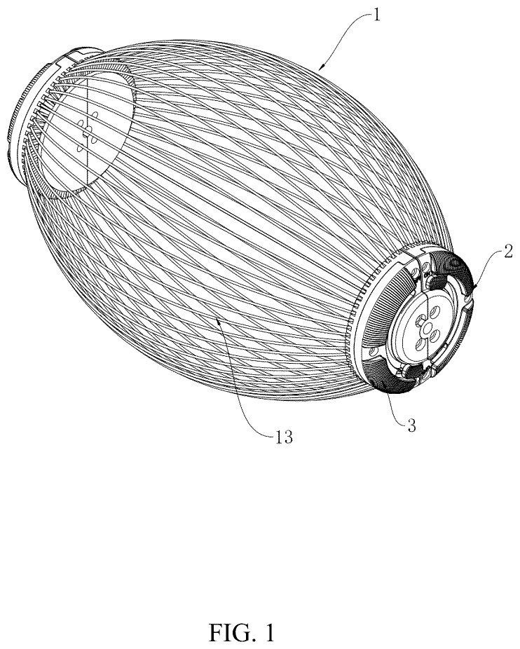

The present embodiment relates to a nut collector, as shown in FIGS. 1 to 6, including a collection cage 1 and two hubs arranged at two ends of the collections cage 1, wherein the collection cage 1 is formed by a plurality of elastic metal wires 13 distributed in a circumference and connected to two hubs at both ends. The collection cage 1 includes: two cages oppositely arranged and capable of being assembled together or separated from each other; each hub includes a first half hub 2, a second half hub 3 and a locking component 4. The first half hub 2 and the second half hub 3 are respectively arranged at one end of the two cages. A part of the blocking component 4 is arranged on the first half hub 2 and other part is arranged on the second half hub 3; the locking component 4 is used for locking or separating the first half hub 2 and the second half hub 3.

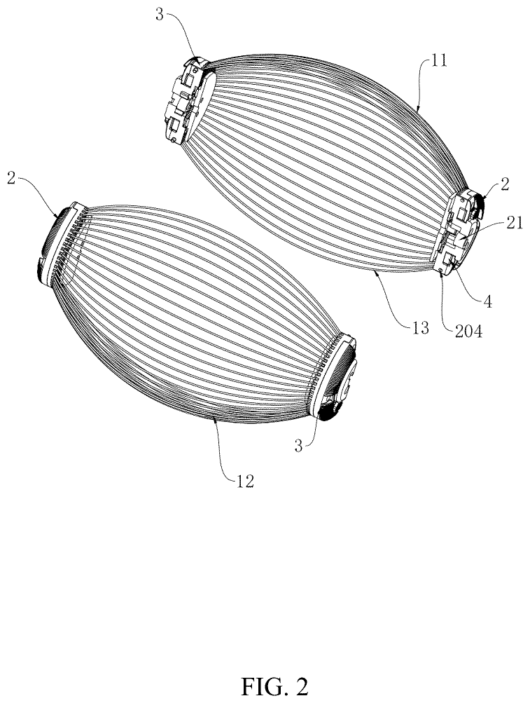

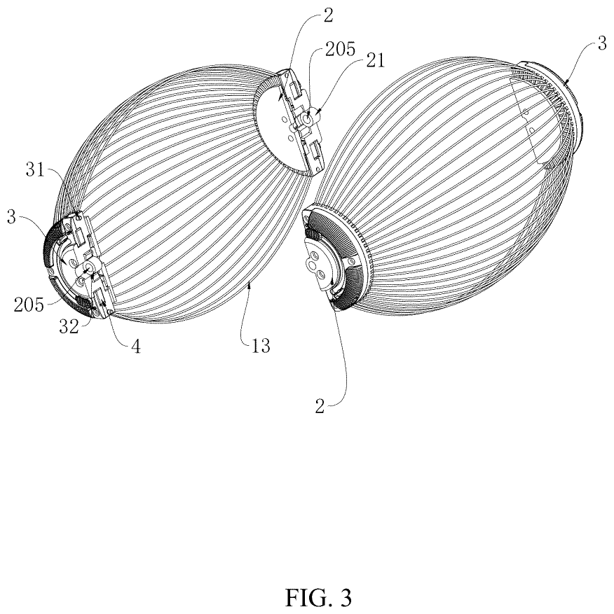

Specifically, as shown in FIGS. 2 and 3, the two cages are the first cage 11 and the second cage 12. The first cage 11 is formed by a plurality of elastic metal wires 13 distributed in a semi-circumference and connected to half hubs of the two hubs respectively at two ends. The second cage 12 is formed by a plurality of elastic metal wires 13 distributed in a semi-circumference and connected to other two half hubs of the two hubs respectively at two ends.

Preferably, two cages can be semi-elliptical, hemispherical or semi-disc shaped. The two cages are capable of being merged as a complete collection cage 1. The first half hub 2 and the second half hub 3 are both semicircular but not limited to semicircular. Preferably, the first half hub 2 and the second half hub 3 are capable of merging as a complete round hub.

It should be noted that the two cages can be assembled as a complete collection cage 1 with the first half hub 2, the second half hub 3 and the locking component 4, which facilitates the user to pick up nuts. When the nuts in the collection cage 1 need to be taken out, the user can open the first half hub 2 and the second half hub 3 through the locking component 4, thereby achieving to separate the collection cage 1 as two halves to facilitate taking out the nuts in the collection cage 1 without pulling apart two adjacent metal wires and prevent the user from scratching, thereby reducing potential safety hazards during use.

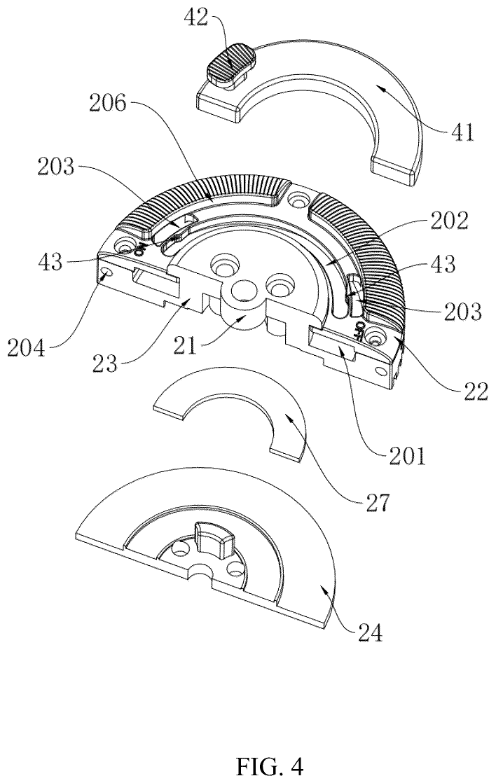

Optionally, in order to achieve that the locking component 4 fixes and assembles two half hubs together or separates two half hubs, thereby achieving to lock and close or open the collection cage 1, the first half hub 2 and the second half hub 3 are arranged symmetrically, so that the two half hubs can be assembled as a complete hub. As shown in FIGS. 4 to 6, the first half hub 2 and the second half hub 3 are oppositely provided with a semicircular first sliding grooves 201 and a second sliding grooves 201 that are connected to each other at two ends. A first guiding groove 202 is arranged on outer side of the first half hub 2. The locking component 4 includes: a first locking block 41 and a first toggle piece 42. The first locking block 41 is slidingly assembled in the first sliding groove 201. One end of the first toggle piece 42 is connected to one end of the first locking block 41, and other end is slidingly assembled on the first guiding groove 202. The first toggle piece 42 can be used for driving the first locking block 41 to extend into the second sliding groove 301 to lock the first half hub 2 and the second half hub 3, or is used for driving the first locking block 41 to retract into the first sliding groove 201 to separate the first half hub 2 and the second half hub 3. The first locking block 41 is in an arc shape with a same shaft center as the first sliding groove 201. Preferably, the first locking block 41 is in the shape of a semicircular bar that is adapted to the first sliding groove 201.

Further, as shown in FIG. 4, in order to make the locking between the first half hub 2 and the second half hub 3 more stable, the locking component 4 further includes: two first limiting convex blocks 43, which are arranged symmetrically. The first limiting convex blocks 43 are arranged on an inner side wall near ends of the first guiding groove 202. When the first locking block 41 extends into the second sliding groove, the two first limiting convex blocks 43 lock the first half hub 2 and the second half hub 3, or when the first locking block 41 is completely retracted into the first sliding groove 201, the first limiting convex block 43 is capable of limiting the sliding of the first toggle piece 42. Preferably, the first half hub 2 is provided with a first hole 203 on outer side of the first guiding groove 202 close to the first limiting convex block 43, and the first hole 203 is used for providing restoring force for the first limiting convex block 43. In this embodiment, the distance between the first limiting convex block 43 and one side opposite to the first limiting convex block 43 on the first guiding groove 202 is slightly smaller than thickness of the first toggle piece 42, so as to facilitate the first limiting convex block 43 to limit the first toggle piece 42.

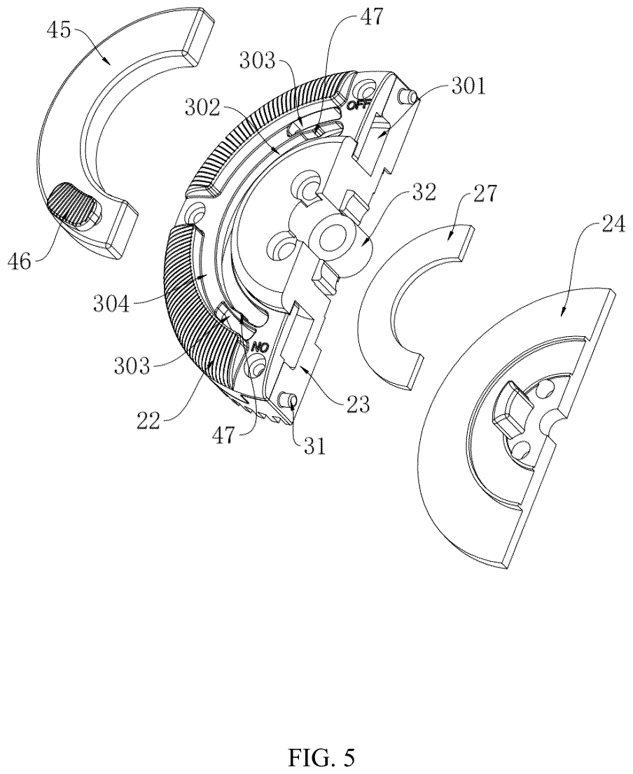

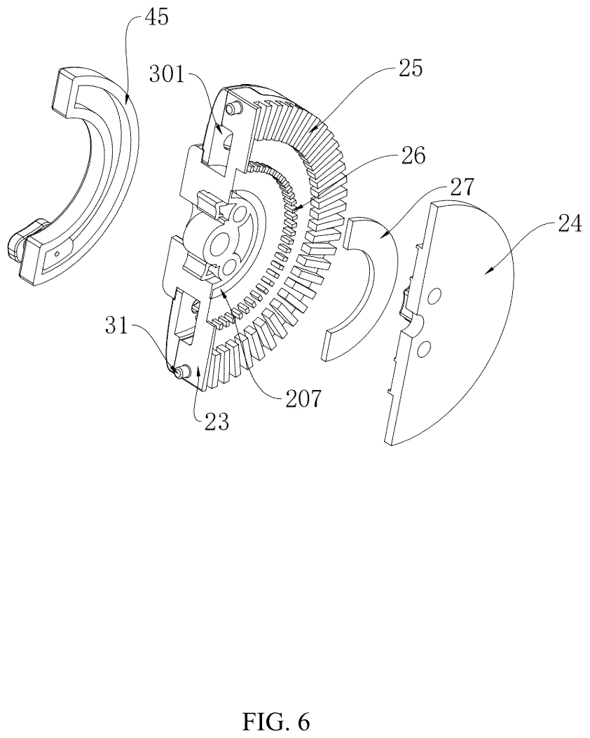

It should be noted that a first opening stopper and a first closing stopper are respectively formed in space between two ends of the first guiding groove 202 and two first limiting convex blocks. When it is necessary to merge the two cages as a complete collection cage 1, firstly push forward the first toggle piece 42 to make the first toggle piece 42 disengage from the first opening stopper, and then push the first toggle piece 42 along the first guiding groove 202 to make the first toggle piece 42 driving the first locking block 41 to slide along the first sliding groove 201 and extend into the second sliding groove 301 until the first toggle piece 42 snaps into the first closing stopper, thereby achieving the first locking block 41 is stably fixed in the second sliding groove 301, achieving locking between the first half hub 2 and the second half hub 3, and then achieving merging the two cages as a complete collection cage 1. When it is necessary to take out the nuts in the collection cage 1 or transport and store them, firstly push the first toggle piece 42 in the reverse direction to make the first toggle piece 42 disengage from the first closing stopper, and then push the first toggle piece 42 along the first guiding groove 202 to make the first toggle piece 42 driving the first locking block 41 to slide along the second sliding groove 301 and the first sliding groove 201 until the first toggle piece 42 snaps into the first opening stopper, so that the first locking block 41 is completely retracted into the first sliding groove 201 to facilitate the removal of nuts or the stacking of two cages, thereby reducing the space occupied by the collection cage 1 and facilitating the storage and transportation of the collection cage 1. Optionally, in order to further stabilize the splicing between the first half hub 2 and the second half hub 3, as shown in FIGS. 5 and 6, outer side of the second half hub 3 is provided with a second guiding groove 302 that is opposite to the first guiding groove 202. The second guiding groove 302 is connected with the second sliding groove 301. The locking component 4 further includes: a second locking block 45 and a second toggle piece 46. The second locking block 45 is slidingly assembled in the second sliding groove 301. The second locking block 45 is oppositely arranged to the first locking block 41. The second locking block 45 and the first locking block 41 can rotate synchronously. One end of the second toggle piece 46 is connected to one end of the second locking block 45, and other end is slidingly assembled on the second guiding groove 302. The second toggle piece 46 is capable of being used for driving the second locking block 45 to extend into the first sliding groove 201 to lock the first half hub 2 and the second half hub 3, or is used for driving the second locking block 45 to retract into the second sliding groove 301 to separate the first half hub 2 and the second half hub 3. The second locking block 45 is in an arc shape and is coaxially arranged with the second sliding groove 301. Preferably, the second locking block 45 is in the shape of a semicircular bar that matches with the second sliding groove 301.

Further, the locking component 4 further includes: two second limiting convex blocks 47 arranged symmetrically. The second limiting convex blocks 47 are arranged on one inner side wall of the second guiding groove 302 near two ends. When the first half hub 2 and the second half hub 3 are in a locked state or an unlocked state, the second limiting convex blocks 47 can limit the sliding of the second toggle piece 46. Preferably, the second half hub 3 is provided with a second hole 303 on outer side of the second guiding groove 302 close to the first limiting convex block 43.

It should be noted that a second opening stopper and a second closing stopper are respectively formed with space between the two second limiting convex blocks 47 and two ends of the second guiding groove 302. When it is necessary to merge the two cages as a complete collection cage 1, firstly push the first toggle piece 42 and the second toggle piece 46 forward with force, so that the first toggle piece 42 and the second toggle piece 46 separate from the first opening stopper and the second opening stopper respectively, and then push the first toggle piece 42 and/or the second toggle piece 46 along the guiding groove, so that the first locking block 41 and the second locking block 45 slide synchronously in the sliding groove and respectively extend into the first sliding groove 201 and the second sliding groove 301 until the first toggle piece 42 and the second toggle piece 46 respectively snap into the first closing stopper and the second closing stopper, thereby ensuring that the first locking block 41 is stably fixed in the second sliding groove 301, and then achieving to merge the two cages as a complete collection cage 1. When it is necessary to take out the nuts in the collection cage 1 or transport and store them, first forcefully push the first toggle piece 42 and the second toggle piece 46 in the opposite direction, so that the first toggle piece 42 and the second toggle piece 46 separate from the first closing stopper respectively, and then push the first toggle piece 42 and the second toggle piece 46 along the guiding groove until the first toggle piece 42 and the second toggle piece 46 snap into the first opening stopper and the second opening stopper respectively, so that the first locking block 41 and the second locking block 45 can completely retract into the first sliding groove 201 and the second sliding groove 301 respectively.

Further, as shown in FIGS. 4 to 6, in order to further ensure that the combined locking between the first half hub 2 and the second half hub 3 is more stable, opposite sides of the first half hub 2 and the second half hub 3 are respectively provided with a positioning groove 204 and a positioning column 31 which is capable of being inserted into each other.

Optionally, a first rotating part 21 and a second rotating part 32 are respectively arranged at shaft centers of the first half hub 2 and the second half hub 3, and the first rotating part 21 and the second rotating part 32 are both provided with a shaft hole 205 in same diameter. When the first half hub 2 and the second half hub 3 are assembled together, the shaft holes 205 on the first rotating part 21 and the second rotating part 32 are arranged concentrically.

Optionally, the nut collector further includes: a handle and a bracket. The handle is connected to top of the bracket. The collection cage 1 is rotatably assembled between two ends of lower part of the bracket. Specifically, the shaft hole 205 of two half hubs are respectively penetrated by two ends of the lower end of the bracket in sequence. In this embodiment, the bracket is a three-head bracket, and the bracket can be arched or V-shaped.

Optionally, as shown in FIGS. 4 to 6, a third guiding groove 206 and a fourth guiding groove 304 are arranged oppositely on outer sides of the first half hub 2 and the second half hub 3. The third guiding groove 206 is connected with the first hole 203 and the first guiding groove 202 respectively, and the fourth guide groove 304 is connected with the second hole 303 and the second guiding groove 302 respectively. The first toggle piece 42 includes: a first sliding rod and a first toggle button. The first sliding rod is penetrated in the first sliding groove 201, and two ends are connected to the first locking block 41 and the first toggle button respectively. The first toggle button is slidingly assembled in the third guiding groove 206. Anti-skid design is arranged on upper surfaces of the first toggle piece 42 and the second toggle piece 46.

Preferably, as shown in FIGS. 4 to 6, each half hub includes a hub cover 22, a hub plate 23 and a fixed board 24 that are arranged in sequence. The rotating part is arranged on the hub plate 23. The hub cover 22 is located on one side of the hub plate 23. The sliding groove is arranged between the hub plate 23 and the hub cover 22. The guiding groove is arranged on the hub cover 22. A first spacer gear group 25 and a second spacer gear group 26 which are concentric and semicircularly distributed on one side of the hub plate 23 away from the hub cover 22. The first spacer gear group 25 is located on periphery of the hub plate 23, the second spacer gear group 26 is distribute inward (toward the shaft of the hub) from circumference of the first spacer gear group 25, so that openings between two adjacent teeth in the first spacer gear group 25 are radially aligned openings between two adjacent teeth in the second spacer gear group 26. The hub plate 23 is provided with a recessed groove 207 on inner side of the second spacer gear group 26. One end of the metal wire extends into the recessed groove 207 along the opening between two adjacent teeth of the first spacer gear group 25 and the opening between two adjacent teeth of the second spacer gear group 26, so that achieving the fixation between ends of the metal wires and the half hubs. A semicircular gasket 27 is arranged between the fixed board 24 and the metal wire. The hub plate 23 is fixed to the hub cover 22 and the fixed board 24 respectively through screws. Optionally, the hub cover 22 can be in the shape of a semicircular ring or a semicircular plate. The fixed board 24 is in the shape of a semicircular plate, and the hub plate 23 is in the shape of a semicircle.

The above only aims to illustrate the technical solution of the present utility patent without limitation. Any other modifications or equivalent replacements of the technical solution of the present utility patent made by ordinary skilled in the art should be included in the scope of the claims of the present utility patent as long as they do not deviate from the technical solution spirit and scope of the present utility patent.

1. A nut collector, comprising a collection cage and two hubs arranged two ends of the collection cage, wherein the collection cage is formed by a plurality of elastic metal wires distributed in a circumference and connected to two hubs at both ends; the collection cage comprises: two cages that are oppositely arranged and can be assembled together or separated from each other;
the hubs comprises a first half hub, a second half hub and a locking component;
the first half hub is arranged at one end of the first cage, and the second half hub is arranged at one end of the second cage;
a part of the blocking component is arranged on the first half hub and other part is arranged on the second half hub; the locking component is used for locking or separating the first half hub and the second half hub.

2. The nut collector according to claim 1, wherein the first half hub and the second half hub are arranged symmetrically; the first half hub and the second half hub are oppositely provided with a semicircular first sliding groove and a second sliding groove that are connected to each other at both ends; a first guiding groove is arranged on outer side of the first half hub; the locking component comprises: a first locking block and a first toggle piece;
the first locking block is slidingly assembled in the first sliding groove;
one end of the first toggle piece is connected to one end of the first locking block and other end is slidingly assembled on the first guiding groove; the first toggle piece is used for driving the first locking block to extend into the second sliding groove to lock the first half hub and the second half hub, or is used for driving the first locking block to retract into the first sliding groove to separate the first half hub and the second half hub.

3. The nut collector according to claim 2, wherein the locking component further comprises two first limiting convex blocks; the two first limiting convex blocks are respectively arranged on inner side wall of the first guiding groove close to two ends;
width of the guiding groove at a position where the first guiding groove is provided with the first limiting convex block is slightly smaller than outer circumferential size of the first toggle piece.

4. The nut collector according to claim 3, wherein the first half hub is provided with a first hole, and the first hole is arranged on one side of the first limiting convex block away from the first guiding groove.

5. The nut collector according to claim 4, wherein outer side of the second half hub is provided with a second guiding groove oppositely arranged with the first guiding groove, and the second guiding groove is connected with the second sliding groove; the locking component further comprises: a second locking block and a second toggle piece;
the second locking block is slidingly assembled in the second sliding groove;
one end of the second toggle piece is connected to one end of the second locking block, and other end is slidingly assembled on the second guiding groove; the second toggle piece is used for driving the second locking block to extend into the first sliding groove to block the first half hub and the second half hub, or is used for driving the second locking block to retract into the second sliding groove to separate the first half hub and the second half hub.

6. The nut collector according to claim 5, wherein the locking component further comprises: two second limiting convex blocks; the two second limiting convex blocks are respectively arranged on inner side wall of the second guiding groove close to two ends; width of guiding groove at a position where the second guiding groove is provided with the second limiting convex block is slightly smaller outer circumferential size of the second toggle piece; the second limiting convex block is capable of limiting the sliding of the second toggle piece.

7. The nut collector according to claim 6, wherein the second half hub is provided with a second hole and the second hole is arranged on one side of the second limiting convex block away from the second guiding groove.

8. The nut collector according to claim 1, wherein the first half hub is provided with a positioning groove, the second half hub is provided with a positioning column, and the positioning groove and the positioning column are oppositely arranged and capable of inserting to each other.

9. The nut collector according to claim 1, wherein the first half hub is provided with a first rotating part at shaft center and the second half hub is provided with a second rotating part at shaft center; both of the first rotating part and the second rotating part are provided with a shaft hole in same diameter; when the first half hub and the second half hub are assembled together, the shaft hole of the first rotating part and the second rotating part are arranged concentrically.

10. The nut collector according to claim 7, wherein the first half hub is provided with a third guiding groove and the second half hub is provided with a fourth guiding groove; the third guiding groove and the fourth guiding groove are oppositely arranged; the third guiding groove are respectively connected with the first hole and the first guiding groove; the fourth guiding groove are respectively connected with the second hole and the second guiding groove;
the first toggle piece comprises: a first sliding rod and a first toggle button, wherein the first sliding rod is arranged to penetrate in the first sliding groove and two ends are respectively connected with the first locking block and the first toggle button; the first toggle button is slidingly assembled in the third guiding groove.
